(19) United States
(12) Patent Application Publication
(10) Pub. No.: US 2014/0246001 A1
(43) Pub. Date: Sep. 4, 2014

(54) CIRCULATION VALVE FOR THE EXHAUST GASES OF AN ENGINE, IN PARTICULAR A MOTOR VEHICLE ENGINE

(71) Applicant: VALEO SYSTEMES DE CONTROLE MOTEUR, Cergy Saint Christophe (FR)

(72) Inventors: Grégory Hodebourg, Sartrouville (FR); Sébastien Adenot, Pontoise (FR)

(73) Assignee: VALEO SYSTEMES DE CONTROLE MOTEUR, Cergy Saint Christophe (FR)

(21) Appl. No.: 14/352,474

(22) PCT Filed: Oct. 11, 2012
(86) PCT No.: PCT/FR2012/052308

§ 371 Date: Apr. 17, 2014

(30) Foreign Application Priority Data
Oct. 20, 2011 (FR) 1159477

(51) Int. Cl. F02M 25/07

(52) U.S. Cl. CPC F02M 25/0774
USPC 123/568.29

(57) ABSTRACT

The invention relates to a circulation valve for the exhaust gases of an engine comprising a body (30) defining a main conduit (31), intended to be connected to an exhaust line of the engine, and an auxiliary conduit (32) opening into said main conduit (31) in order to recirculate the exhaust gases, said valve further comprising a shutter (1) movable between two positions of closure, which prevents communication between the two conduits (31, 32), and full recirculation, which allows said conduits (31, 32) to be brought into communication, valve in which said body (30) and said shutter (1) are mutually configured such that, in said full recirculation position, said shutter (1) blocks said main conduit (31) by 65 to 95%.

The present invention concerns a circulation valve for the exhaust gases of an engine, in particular a motor vehicle engine.

Said valve is intended to adjust, for example, a flow of exhaust gases directed toward the inlet line of the engine to be mixed with cool air before being introduced into said engine. In particular, it could be used in engine architectures, notably diesel engine architectures, employing a turbocompressor, said valve being provided on the exhaust line of the engine downstream of the turbine of the turbocompressor to take off some of the gases.

There has already been proposed a valve including a body defining a main conduit, intended to be connected to the exhaust line of the engine, and an auxiliary conduit for recirculation of the exhaust gases, said auxiliary conduit and said main conduit being connected to each other. Said valve further includes a shutter mobile between a closing position preventing communication between the two conduits and a full recirculation position enabling communication to be established between said conduits.

It has been shown by the applicant in the context of the present invention that although the valve has to encourage the circulation of the exhaust gases in the auxiliary conduit in the recirculation position, it must not risk choking the engine. Accordingly, even if the shutter must seal the main conduit when in the closing position, it is conversely necessary to retain a sufficient leakage flow rate in said main conduit in the recirculation position.

First trials based on the use of operating clearances between the shutter and the body of the valve to create such a leakage flow rate have demonstrated the insufficiency of such a solution and the invention aims to improve on this situation.

To this end it proposes a circulation valve for the exhaust gases of an engine including a body defining a main conduit, intended to be connected to an exhaust line of the engine, and an auxiliary conduit opening into said main conduit in order to recirculate the exhaust gases, said valve further including a shutter movable between a closing position, preventing communication between the two conduits, and a full recirculation position, enabling communication to be established between said conduits, in which valve said body and said shutter are mutually configured such that, in said full recirculation position, said shutter blocks 65 to 95%, notably 70 to 75%, of said main conduit.

It is found that by freeing in this way a greater area of passage between the shutter and the body, the risks of choking the engine are considerably reduced at the same time as ensuring a flow rate in the auxiliary conduit enabling a satisfactory level of recirculation of the exhaust gases.

In accordance with various embodiments of the invention, which may be used separately or in combination:
said auxiliary conduit opens into said main conduit via a passage window and said shutter closes said passage window when in the closing position, said shutter including a diverter flap partially closing said main conduit, notably downstream of the auxiliary conduit, when the shutter is in the full recirculation position,
the diverter flap and the body of the valve are configured so that when the shutter is in the full recirculation position a slot is formed between said diverter flap and said body,
said diverter flap has a free edge facing the body and said slot is located all along said free edge,
the slot has a constant thickness between the free edge and the body in the full recirculation position,
said diverter flap has a rectangular contour and said main conduit has a substantially rectangular section at least in line with the location of the diverter flap when the shutter is in the full recirculation position,
the shutter is mounted to pivot in the body about an articulation shaft and the shutter includes a blocking flap connected to the diverter flap by an intermediate area, the articulation shaft being at a distance from the shutter, the blocking flap closing the passage window when the shutter is in the closing position,
said valve further includes a seal including an opening in corresponding relationship with said passage window for the circulation of the fluid, said shutter closing said opening when in the closing position,
said shutter further includes a blocking flap connected to the diverter flap by an intermediate area, said blocking flap blocking said opening of the seal when the shutter is in the closing position, said blocking flap and said diverter flap then being on opposite sides of the seal while said intermediate area passes through said opening of the seal,
the valve includes an articulation shaft of the shutter in the vicinity of the intermediate area of the shutter and said blocking flap has a dimension extending on each side beyond the dimension over which said diverter flap extends, in the direction of the articulation shaft of the shutter,
said diverter flap and said intermediate area extend over substantially the same distance in said direction of the articulation shaft of the shutter,
said seal includes a plane area having a surface against which one plane bearing face of said blocking flap comes to bear and/or an opposite surface against which one plane bearing face of the diverter flap comes to bear when the shutter is in the closing position, said opening in the seal for the passage of the fluid being positioned at the level of said plane area,
said bearing surface of the blocking flap and said bearing surface of the diverter flap of the shutter lie in two spaced parallel planes,
said planes are spaced by a distance corresponding to the thickness of the seal in said plane area,
the diverter flap of the shutter has a surface opposite its plane bearing surface and the intermediate area has an inclined flat between the bearing face of the blocking flap and said opposite face,
said seal has a boss along a portion of the passage opening, facing the diverter flap of the shutter when the latter is in the closing position, said boss being configured to be compressed by said diverter flap of the shutter when the latter is in the closing position,
said seal may notably include a blind area facing said diverter flap when the shutter is in the closing position,
said body includes, for example, a housing for a motor for actuating the shutter, said body being configured to define an air jet between said blind area and said housing.

The invention will be better understood in the light of the following description given by way of non-limiting illustration only and accompanied by the appended drawings, in which:

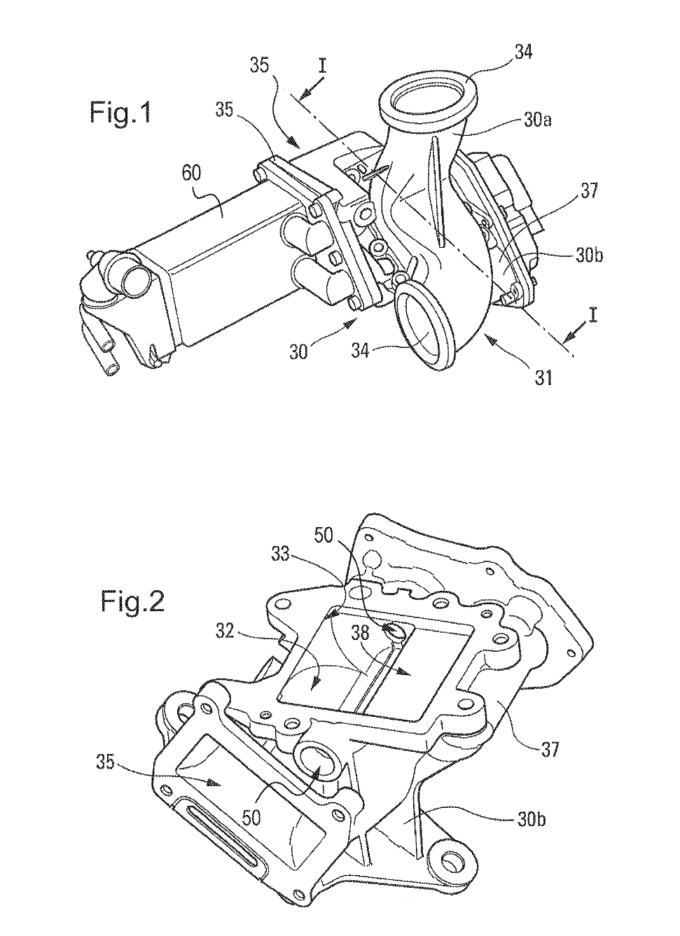

FIG. 1 is a perspective view of a valve in accordance with the invention, associated with a heat exchanger,

FIG. 2 is a perspective view of a portion of the valve from FIG. 1,

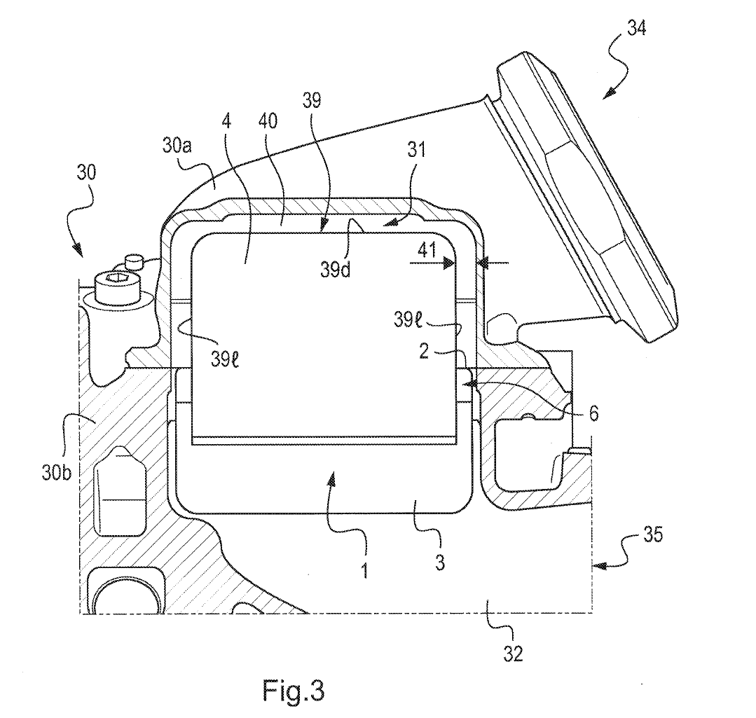

FIG. 3 is a sectional view of the aforementioned valve from FIGS. 1 and 2, in a section plane oriented according to the diverter flap of the shutter of the valve in the full recirculation position,

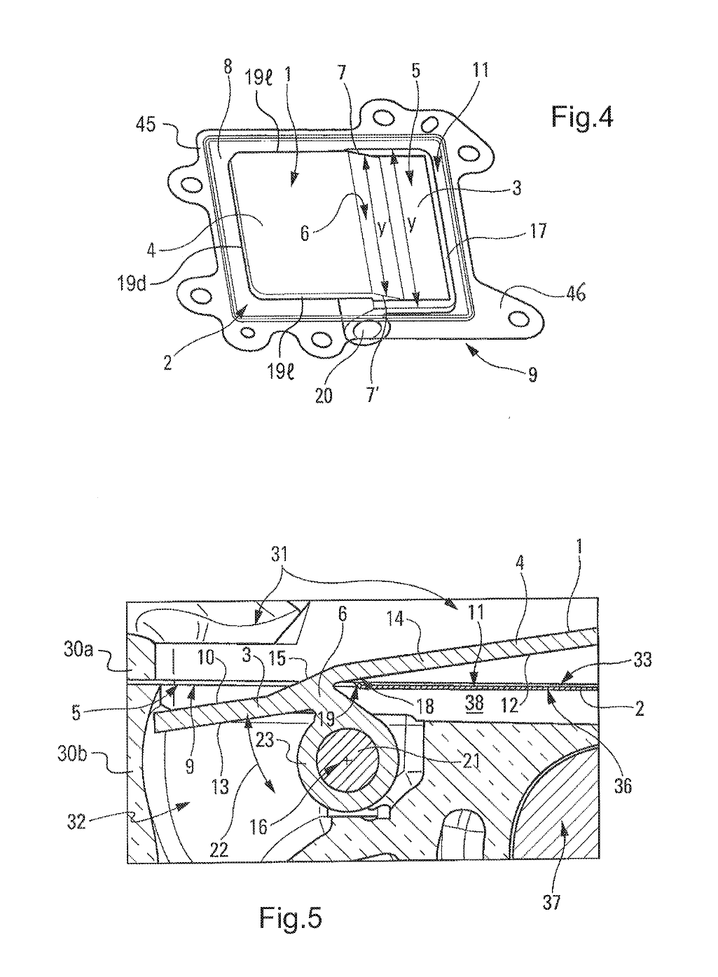

FIG. 4 is a perspective view of a seal and a shutter intended to be mounted in the valve from the preceding figures,

FIG. 5 is a sectional view on a section plane orthogonal to the articulation shaft of the shutter showing the seal and the shutter from FIG. 4 mounted in their valve, the shutter being in an intermediate position between its closing position and its full recirculation position.

As shown in FIGS. 1 and 2, the invention concerns a valve for circulating exhaust gases from an engine, notably a motor vehicle engine. It could in particular be a valve enabling flow of the exhaust gases along the exhaust line of the engine and recirculation of the gases to the inlet of the engine.

Said valve includes a body 30 defining a main conduit 31 and an auxiliary conduit 32 for the flow of the fluid, opening into said main conduit 31. The main conduit 31 is intended to be connected to the exhaust line of the engine and the auxiliary conduit serves to recirculate exhaust gases.

The main conduit includes, for example, inlet and outlet orifices 34 intended to communicate with the exhaust line of an engine. The auxiliary conduit includes an orifice 35 communicating, for example, with an exhaust gases recirculation line. Here said recirculation line includes a heat exchanger 60 into which the exhaust gases discharge on leaving the orifice 35. Said body 30 notably further includes a housing 37 for a motor for actuating the shutter.

As shown in FIG. 3, said valve further includes a shutter 1 mobile between two positions, a first or closing position, preventing communication between the two conduits 31, 32, and a second or full recirculation position, enabling communication to be established between said conduits 31, 32. Said shutter could naturally also occupy any position between these two closing and full recirculation extreme positions. In FIG. 3, the shutter is in the full recirculation position. The valve is configured so that it is in this position of the shutter that the gas flow rate in the auxiliary conduit 32 is at a maximum.

In accordance with the invention, said body 30 and said shutter 1 are mutually configured so that, in said full recirculation position, said shutter blocks said main conduit 31 by 65 to 95%. It has in fact been found that the quantity of exhaust gases continuing to circulate in the exhaust line is then sufficient to limit the risks of choking the engine and the quantity of exhaust gases diverted in the auxiliary conduit 32 enables the required recirculation flow rates to be achieved.

Particularly advantageous results have been obtained when the shutter 1 blocks the main conduit 31 by 65 to 80%, notably 70 to 75%.

Said auxiliary conduit 32 notably discharges into said main conduit 31 via a passage window 33 (seen better in FIG. 2), said shutter 1 closing said passage window 33 when in the closing position. Moreover, said shutter 1 includes, for example, a so-called diverter flap 4 partially closing said main conduit 31 when the shutter 1 is in the full recirculation position. Said diverter flap 4 has a free edge 39 facing the body 30.

The diverter flap 4 and the body 30 of the valve are configured here so that, when the shutter 1 is in the full recirculation position, a slot 40 is formed between said diverter flap 4 and said body 30. It is therefore thanks to said slot 40 that the shutter 1 blocks the main conduit only to the degree indicated above.

Said slot 40 is located, for example, all along said free edge 39 and could have a constant thickness between the free edge 39 and the body 30 in the full recirculation position. By thickness is meant the dimension, indicated by the arrow 41 shown in FIG. 3, between the free edge 39 of the diverter flap 4 and the portion of the wall of the main conduit 31 facing said diverter flap 4 in the fully open position.

Here said diverter flap 4 has a rectangular contour and said main conduit 31 has a substantially rectangular section, at least in line with the location of the diverter flap 4 when the shutter 1 is in the full recirculation position.

Said free edge 39 includes, for example, a distal portion 39d and two opposite lateral portions 39l connecting the distal edge 39d to the rest of the shutter 1. Here the free edge 39 has a radius connecting the distal edge 39d to the lateral edges 39l. It could have a value between 5 and 40 mm.

By way of non-limiting example, the diverter flap 4 has an area between 20 and 30 cm² and the width of the slot is between 3 and 5 mm. To be more precise, the diverter flap 4 could have an area of approximately 25 cm² for a slot of approximately 4 mm.

As shown in FIGS. 4 and 5, the valve in accordance with the invention could further include a seal 2 including an opening 5 for the passage of the exhaust gases. Said opening 5 of the seal therefore enables passage of the fluid from one conduit 31 to the other conduit 32. In other words, said opening 5 of the seal 2 faces the window 33 of the body 30. Said seal 2 serves as a seat for said valve 1 when in the closing position.

In its full recirculation position (FIG. 3), the shutter 1 is inclined relative to the seal 2, for example by 25 to 65°.

Here the shutter 1 further includes a so-called blocking flap 3 connected to the diverter flap 4 by an intermediate area 6. Said blocking flap 3 blocks said opening 5 of the seal 2 when the shutter 1 is in the closing position. In the same closing position of the shutter, the blocking flap 3 and the diverter flap 4 are on respective opposite sides of and transverse to the seal 2 to allow the fluid to pass, while the intermediate area 6 connecting said blocking flap 3 and said diverter flap 4 passes through said opening 5 of the seal 2, for example flush therewith, at the level of the areas 7, 7′ of the contour of said opening 5 of the seal.

It is therefore possible to obtain a seal around the opening 5 of the seal at the same time as allowing movement of the shutter between its full recirculation position and its closing position without having to leave large clearances between the opening 5 of the seal 2 and the contour of the shutter 1.

Said seal 2 includes a plane area 8 including a surface 9 against which a plane bearing face 10 of the blocking flap 3 comes to bear and/or an opposite surface 11 against which a plane bearing face 12 of the diverter flap 4 comes to bear when the shutter 1 is in the closing position. Said opening 5 in the seal 2 for the passage of the fluid is positioned at the level of said plane area 8. The seal is therefore provided by a face-against-face contact at the level of said flange or flanges.

For example, said bearing surface 10 of the blocking flap and said bearing surface 12 of the diverter flap of the shutter lie in two spaced parallel planes, for example at a distance corresponding to the thickness of the seal in said plane area 8. Plane-on-plane type contacts can therefore be provided.

The blocking flap 3 includes a surface 13 opposite the bearing surface 10 and the blocking flap 4 includes a surface 14 opposite its bearing surface 12. These two opposite faces 13, 14 are plane, for example, and the intermediate area 6 includes an inclined flat 15 between the bearing face 10 of the blocking flap 3 and said opposite face 14 of the diverter flap 4. This encourages the flow of the fluid over the surface of the shutter.

Here the valve includes an articulation shaft 16 of the shutter 1 that is eccentric relative to said flanges 3, 4 and located in the vicinity of the intermediate area 6 of the shutter, for example.

In the direction of the articulation shaft of the shutter, said blocking flap 3 has a dimension y extending on both sides beyond the dimension y′ over which the intermediate area 6 extends, at least at the level of a junction area between said intermediate area and said blocking flap 3. The dimension y′ of the intermediate area 6 and the dimension of the blocking flap 4 in said direction of the rotation shaft of the shutter 1 could be identical. In other words, the dimension of the blocking flap 4 in said direction of the rotation shaft of the shutter 1 could be less than the dimension y of the blocking flap 3.

The bearing surface 10 of the blocking flap 3 can therefore include an area 17 of contact with the seal 2 in the form of an angular portion of a ring over a first part of the periphery of the opening 5 of the seal, on one side of said seal, while the bearing surface 12 of the diverter flap 4 includes a contact area 18 on the other side of the seal over a complementary portion of the periphery of the opening 5 of the seal.

The contact area 17 of the blocking flap 3 also lines up with the intermediate area 6 at the level of the areas 7, 7′. This therefore reinforces the seal and there could be an intermediate area 6 that is not flush with the contour of the opening 5 of the seal.

The opening 5 of the shutter has a substantially rectangular contour, for example, like the blocking shutter 3. And the contact area 17 of said blocking flap 3 extends along three of the sides of said opening 5. As for the contact area 18, it extends along the last side. Said intermediate area faces the contour of said opening 5 over a portion of two of its opposite sides. The contact area 17 of the blocking flap 3 is extended in line with said intermediate part 6, at the level of the areas 7, 7′. As for the blocking flap 4, as already stated, it is also of substantially rectangular shape.

The seal 2 includes a peripheral portion 45 for example and said plane area 8 is set back from the peripheral portion. Such a seal is obtained, for example, by a pressing operation. Said peripheral portion 45 could have extensions 46 forming a flange for attaching it to the body 30.

As more particularly shown in FIG. 5, said seal 2 includes a boss 19 along a portion of the opening 5 of the seal, facing the diverter flap 4 of the shutter when the latter is in the closing position. Said boss 19 is configured to be compressed by the diverter flap 4 of the shutter when the latter is in the closing position. This further improves the seal.

The shutter 1 includes a housing 20 for an articulation shaft 21, for example. It is notably a question of a rotational articulation about the articulation shaft 16, as shown by the arrow 22. For example, said housing is located in an extension 23 of the intermediate area 6 extending from the opposite face 13 to the bearing face 10 of the blocking flap and from the bearing face 12 of the diverter flap 4 of the shutter.

Here the housing 20 is a through-housing and the shaft 21 projects out of the housing 20 on each side. Said shaft 21 is rotationally articulated in orifices 50 (visible in FIG. 2) in the body 30. The shaft 21 is connected to the extension 23 in a manner known in itself.

The blocking flap 3, the diverter flap 4, the intermediate area 6 and its extension 23 form a single part, for example, notably a casting.

Said seal 2 could include a blind area 36 facing said diverter flap 4 when the shutter 1 is in the closing position. In other words, as already explained above, the opening 5 of the seal exists only at the level of the blocking flap 3 when the shutter 1 is in the closing position.

Said body 30 could moreover be configured to define an air jet 38 between said blind area 36 of the seal and said housing 37. This improves the thermal insulation of the engine. Said extension 23 of the shutter receiving its articulation shaft 21 is positioned so as to close said fluid jet 38.

Referring again to FIGS. 1 and 2, it is seen that said body 30 could be made in two parts 30a, 30b, each part defining one of said conduits 31, 32, and including an opening coming into corresponding relationship to define said window 33. Said seal then has a sealing function between said two parts 30a, 30b relative to the exterior of the valve.

Here the orifices 50 for the articulation shaft 21 are in the part 30b defining the auxiliary conduit 32.

Said valve may moreover include a transmission system, not shown, between an output shaft of the engine and the articulation shaft 21 of the shutter 1.

1. A circulation valve for the exhaust gases of an engine comprising:
a body defining a main conduit, intended to be connected to an exhaust line of the engine, and an auxiliary conduit opening into said main conduit in order to recirculate the exhaust gases
a shutter movable between a closing position, preventing communication between the two conduits, and a full recirculation position, enabling communication to be established between said conduits, in which valve said body and said shutter are mutually configured such that, in said full recirculation position, said shutter blocks 65 to 95% of said main conduit,
said auxiliary conduit opening into said main conduit via a passage window and said shutter closing said passage window when in the closing position, said shutter including a diverter flap partially closing said main conduit when the shutter is in the full recirculation position,
the shutter being mounted in the body to pivot about an articulation shaft and the shutter including a blocking flap closing the passage window when the shutter is in the closing position, said blocking flap being connected to the diverter flap by an intermediate area, the articulation shaft being at a distance from the shutter.

2. The valve according to claim 1, wherein the diverter flap and the body of the valve are configured so that when the shutter is in the full recirculation position a slot is formed between said diverter flap and said body.

3. The valve according to claim 2, wherein said diverter flap has a free edge facing the body and said slot is located all along said free edge.

4. The valve according to claim 3, wherein the slot has a constant thickness between the free edge and the body in the full recirculation position.

5. The valve according to claim 4, wherein said diverter flap has a rectangular contour and said main conduit has a substantially rectangular section at least in line with the location of the diverter flap when the shutter is in the full recirculation position.

6. The valve according to claim 1, further comprising a seal including an opening in corresponding relationship with said passage window for the circulation of the fluid, said shutter closing said opening when in the closing position.

7. The valve according to claim 6, said blocking flap blocking said opening of the seal when the shutter is in the closing position, said blocking flap and said diverter flap then being on opposite sides of the seal while said intermediate area passes through said opening of the seal.

8. The valve according to claim 7, the articulation shaft of the shutter being in the vicinity of the intermediate area of the shutter and said blocking flap having a dimension in the direction of the articulation shaft of the shutter extending on each side beyond the dimension over which said diverter flap extends.

9. The valve according to claim 8, wherein said diverter flap and said intermediate area extend over substantially the same distance in said direction of the articulation shaft of the shutter.
